(19) United States
(12) Patent Application Publication
(10) Pub. No.: US 2014/0090080 A1
(43) Pub. Date: Mar. 27, 2014

(54) ELECTRONIC APPARATUS AND CONTROL METHOD

(71) Applicant: KABUSHIKI KAISHA TOSHIBA, Tokyo (JP)

(72) Inventor: Toshiyuki Koga, Tokyo (JP)

(21) Appl. No.: 13/942,399

(22) Filed: Jul. 15, 2013

(30) Foreign Application Priority Data
Sep. 26, 2012 (JP) 2012-213029

(51) Int. Cl. G06F 21/44

(52) U.S. Cl. CPC G06F 21/44
USPC 726/27

(57) ABSTRACT

According to one embodiment, an electronic apparatus includes a close proximity communication module and a controller. The close proximity communication module executes close proximity communication. The controller receives, by using the close proximity communication, first account information from an external apparatus close to the electronic apparatus in response to an account setting request from the external apparatus, and sets the first account information in the electronic apparatus. The first account information is information for logging in to a server system configured to provide a certain service.

### CROSS-REFERENCE TO RELATED APPLICATIONS

This application is based upon and claims the benefit of priority from Japanese Patent Application No. 2012-213029, filed Sep. 26, 2012, the entire contents of which are incorporated herein by reference.

### FIELD

Embodiments described herein relate generally to an electronic apparatus having a communication function, and a control method which is applied to the electronic apparatus.

### BACKGROUND

Recently, various electronic apparatuses such as a tablet computer and a personal computer (PC) have been developed. Many electronic apparatuses of this type have a network communication function to communicate with various sites on the Internet.

Some sites on the Internet can provide various types of services such as mail service and image browsing service. A user creates an account of the user on a site in advance. Thus, the user can use various types of services by logging in to the site.

When, however, a user intends to use another service which cannot be used even by using the current account, the user needs to perform setting operation (account creating operation, login operation, and the like) to allow the use of the service.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an electronic apparatus according to an embodiment;

FIG. 2 is an exemplary view to explain an outline of a system including the electronic apparatus according to the embodiment;

FIG. 3 is an exemplary block diagram showing the system configuration of the electronic apparatus according to the embodiment;

FIG. 4 is an exemplary block diagram showing the configuration of a setting change program executed by the electronic apparatus according to the embodiment;

FIG. 5 is an exemplary flowchart to explain a procedure for setting change processing executed by the electronic apparatus according to the embodiment; and

FIG. 6 is an exemplary flowchart to explain a procedure for setting deletion processing executed by the electronic apparatus according to the embodiment.

### DETAILED DESCRIPTION

Various embodiments will be described hereinafter with reference to the accompanying drawings.

In general, according to one embodiment, an electronic apparatus includes a close proximity communication module and a controller. The close proximity communication module executes close proximity communication. The controller receives, by using the close proximity communication, first account information from an external apparatus close to the electronic apparatus in response to an account setting request from the external apparatus, and sets the first account information in the electronic apparatus. The first account information is information for logging in to a server system configured to provide a certain service.

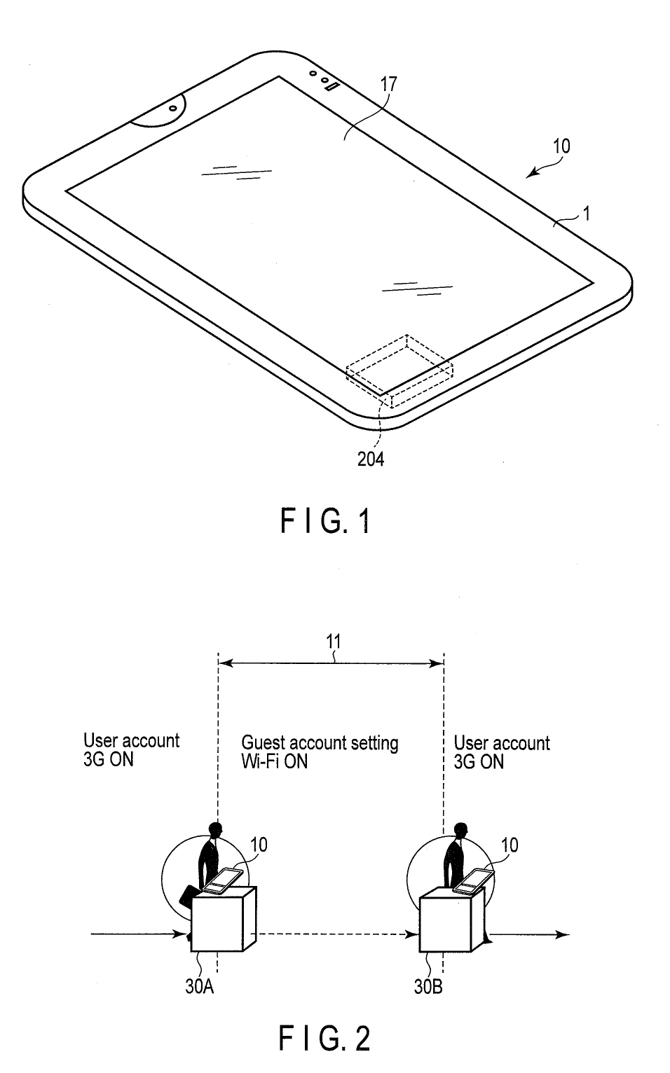

The outer appearance of the electronic apparatus according to an embodiment will be described with reference to FIG. 1. The electronic apparatus according to this embodiment is implemented by, for example, a tablet computer 10. This electronic apparatus may be implemented as a notebook type personal computer, smartphone, PDA, or the like.

The tablet computer 10 is constituted by a computer main body 1 and a touch screen display 17. The computer main body 1 has a thin box like housing. The touch screen display 17 is placed on the upper surface of the computer main body 1. The touch screen display 17 includes a flat panel display (e.g., an LCD (Liquid Crystal Display)) and a touch panel. The touch panel is provided to cover the screen of the flat panel display. The touch panel is configured to detect the position on the touch screen display 17 at which the user has touched with his/her finger or a pen. The tablet computer 10 also includes a close proximity communication module 204 which can be able to perform close proximity communication (e.g., NFC: Near Field Communication). The tablet computer 10 has a setting change function of changing, by performing close proximity communication with an external apparatus, various settings for defining the internal operation environment of the tablet computer 10.

An outline of this embodiment will be described next with reference to FIG. 2.

The setting change function of this embodiment is used at, for example, the entrance and exit of facilities such as a museum, art museum, or airport. Assume that the user enters facilities such as a museum, art museum, or airport or exits from the facilities. The user can automatically change various settings in the tablet computer 10 by holding the tablet computer 10 equipped with the close proximity communication module 204 over a reader/writer 30A or reader/writer 30B which can be able to perform close proximity communication, i.e., bringing the tablet computer 10 close to the reader/writer 30A or 30B. Various settings in the tablet computer 10 include account settings, wireless connection settings, volume settings or vibration settings in the tablet computer 10, and time settings in the tablet computer 10. The account settings are settings concerning account information for logging in to server systems which provide specific services. The specific services include, for example, browsing of images or videos (moving images) or acquisition of announcement information in the facilities. The wireless connection settings are settings concerning wireless connection of the tablet computer 10.

The reader/writer 30A and the reader/writer 30B are apparatuses for transmitting and receiving information by performing close proximity communication with the tablet computer 10 via the close proximity communication module 204 of the tablet computer 10. Referring to FIG. 2, the reader/writer 30A is an apparatus which is provided at the entrance of facilities like those indicated by an area 11. The reader/writer 30B is an apparatus which is provided at the exit of facilities like those indicated by the area 11. Note that the reader/writer 30A and the reader/writer 30B may be physically identical apparatuses.

More specifically, FIG. 2 assumes a case in which account settings and wireless connections settings are changed. The user of the tablet computer 10 has sometimes already created an account corresponding to the user on a predetermined server system by signing up the server system. The user of the tablet computer 10 usually logs in to the server system by using the created user account. In this case, the tablet computer 10 holds account information (an account ID like a mail address, and a password) indicating the user account. When entering the facilities, the user holds the tablet computer 10 including the close proximity communication module 204 over the reader/writer 30A (this operation will be referred to as close proximity communication at the time of entrance hereinafter), and enters the area 11. By performing close proximity communication at the time of entrance, the account in the tablet computer 10 which is to be used to log in to the above server system is changed from the above user account to another account (e.g., a guest account capable of logging in to the above server system) which can be used in the area 11. Another account (guest account) is an account which can use specific services provided in the area 11. That is, the tablet computer 10 receives account information for logging in to the above server system from the reader/writer 30A by using close proximity communication. This received account information is information indicating a predetermined account (a predetermined guest account) which can be used in the area 11. For example, a plurality of accounts (a plurality of guest accounts) to be used in the area 11 may be created in the server system in advance. In this case, the reader/writer 30A transmits account information indicating one of these guest accounts to the tablet computer 10 by using close proximity communication. The tablet computer 10 sets the account information, which is received from the reader/writer 30A by using close proximity communication, in the tablet computer 10. The tablet computer 10 can use a specific service associated with the area 11 by logging in to the above server system by using the received account information.

At the time of exit, the user holds the tablet computer 10 over the reader/writer 30B (this operation will be referred to as close proximity communication at the time of exit hereinafter), and exits from the area 11. Performing close proximity communication at the time of exit will automatically delete the above account information (guest account) set in the tablet computer 10 at the time of entrance. In addition, the account in the tablet computer 10 which is used to log in to the above server system is changed back from the guest account to the user account.

Referring to FIG. 2, performing close proximity communication at the time of entrance will change the wireless connection settings in the tablet computer 10 from wireless communication settings using a mobile communication module (3G or the like) to wireless communication settings using a wireless LAN (WiFi® or the like). Performing close proximity communication at the time of exit will change the wireless connection settings in the tablet computer 10 from the wireless communication settings using a wireless LAN (WiFi® or the like) to the wireless communication settings using a mobile communication module (3G or the like).

As described above, by only holding the tablet computer 10 over the reader/writer 30A at the time of entrance to the area 11, a guest account will automatically set. This allows the user to use a certain service without setting a guest account by himself/herself. In addition, the wireless connection settings are automatically changed. This makes it possible to use a certain service by using wireless communication using a wireless LAN which is relatively stable as compared with wireless communication using a mobile communication module. Even if the user cannot use wireless communication using the mobile communication module, he/she can use a certain service without making wireless connection settings by himself/herself. In addition, deleting a guest account from the tablet computer 10 at the time of exit can prevent the user from using the certain service after the exit. Furthermore, it is possible to reuse a guest account (account information corresponding to a guest account) deleted from the tablet computer 10 for making settings in another computer which enters the area 11.

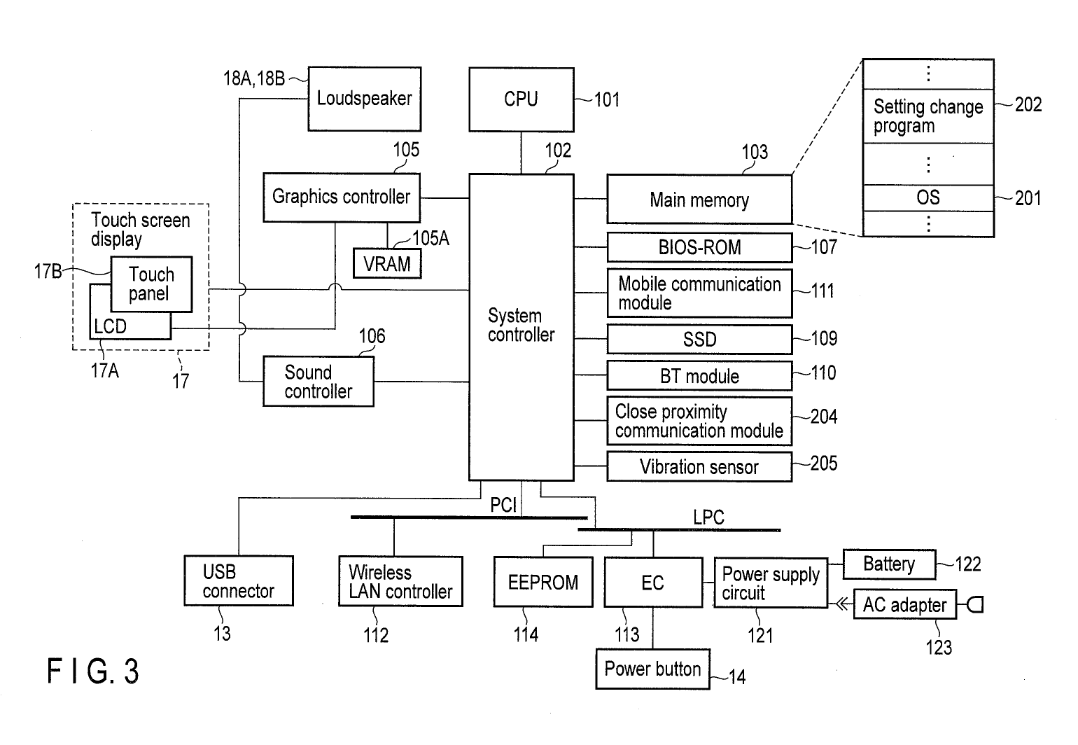

The system configuration of the electronic apparatus according to this embodiment will be described next with reference to FIG. 3.

The tablet computer 10 includes a central processing apparatus (CPU) 101, a system controller 102, a main memory 103, a graphics controller (GPU) 105, a sound controller 106, a BIOS ROM 107, a solid state drive (SSD) 109, a BT (Bluetooth®) module 110, a mobile communication module 111, a wireless LAN controller 112, an EC (Embedded Controller) 113, an EEPROM 114, a USB connector 13, a touch screen display 17, a video memory (VRAM) 105A, a close proximity communication module 204, and a vibration sensor 205.

The CPU 101 is a processor which controls the operation of each module in the tablet computer 10. The CPU 101 executes an OS (Operating System) 201 and various types of application programs which are loaded from the SSD 109 into the main memory 103. The application programs include a setting change program 202.

The setting change program 202 is a program for changing various settings like those described above in the tablet computer 10. The setting change program 202 can also activate, for example, a content browsing application for browsing a content obtained from an external content server.

The content browsing application is an application program for browsing a content such as image (still image) data, e.g., photograph data, or video (moving image) data. Alternatively, the content browsing application may be an application program for receiving, for example, announcement information in a specific area by mail.

The CPU 101 executes the BIOS (Basic Input/Output System) stored in the BIOS ROM 107. The BIOS is a program for hardware control.

The system controller 102 is a bridge device for connecting between a local bus of the CPU 101, and each device on a PCI (Peripheral Component Interconnect) bus and each device on an LPC (Low Pin Count) bus. The system controller 102 also incorporates an IDE (Integrated Drive Electronics) controller for controlling the SSD 109. The system controller 102 also has a function of executing communication with the sound controller 106. The system controller 102 also has a function of executing communication with the GPU 105 via a serial bus complying with the PCI EXPRESS standards.

The GPU 105 is a display controller which controls an LCD 17A used as the display monitor of the tablet computer 10. The video signal (also called the display signal) generated by the GPU 105 is sent to the LCD 17A.

The sound controller 106 is a sound source device. This device outputs audio data to be reproduced to loudspeakers 18A and 18B. The wireless LAN controller 112 is a wireless communication device which executes wireless communication complying with, for example, the IEEE802.11 standards.

The EC 113 is an embedded controller for power management. The EC 113 has a function of powering on/off the tablet computer 10 in accordance with operation by the user. A power supply circuit 121 generates operating power to be supplied to each component by using the power supplied from a battery 122 in the tablet computer 10 or the power supplied from an external power supply such as an AC adapter 123. The power supply circuit 121 also charges the battery 122 by using the power supplied from an external power supply.

The touch screen display 17 incorporates a touch panel 17B in addition to the LCD 17A. The touch panel 17B mounted on the LCD 17A includes a sensor and an MCU (Micro Controller Unit). When the user performed touch-operation on the touch panel 17B, the sensor detects the touched position. The MCU then outputs input information including the touched position on the touch panel 17B.

The video memory (VRAM) 105A is connected to the GPU 105. The video memory (VRAM) 105A stores, for example, screen image data corresponding to the screen image displayed on an external display or the LCD 17A.

The mobile communication module 111 performs wireless communication using a cellular phone communication network, e.g., wireless communication complying with the 3G communication standards. Note that the mobile communication module 111 may perform any wireless communication as long as it complies with standards different from those of wireless communication performed by the wireless LAN controller 112 and close proximity communication, and may perform wireless communication using a communication network different from the cellular phone communication network.

The close proximity communication module 204 has a function for performing NFC like that described above. Note that the close proximity communication module 204 may perform any wireless communication as long as it differs from wireless communication performed by the wireless LAN controller 112 and the mobile communication module 111, and may perform, for example, short distance communication capable of communicating over a longer distance between apparatuses in communication with each other than close proximity communication.

The vibration sensor 205 can vibrate the tablet computer 10 based on a vibration setting as one of various settings in the tablet computer 10 described above.

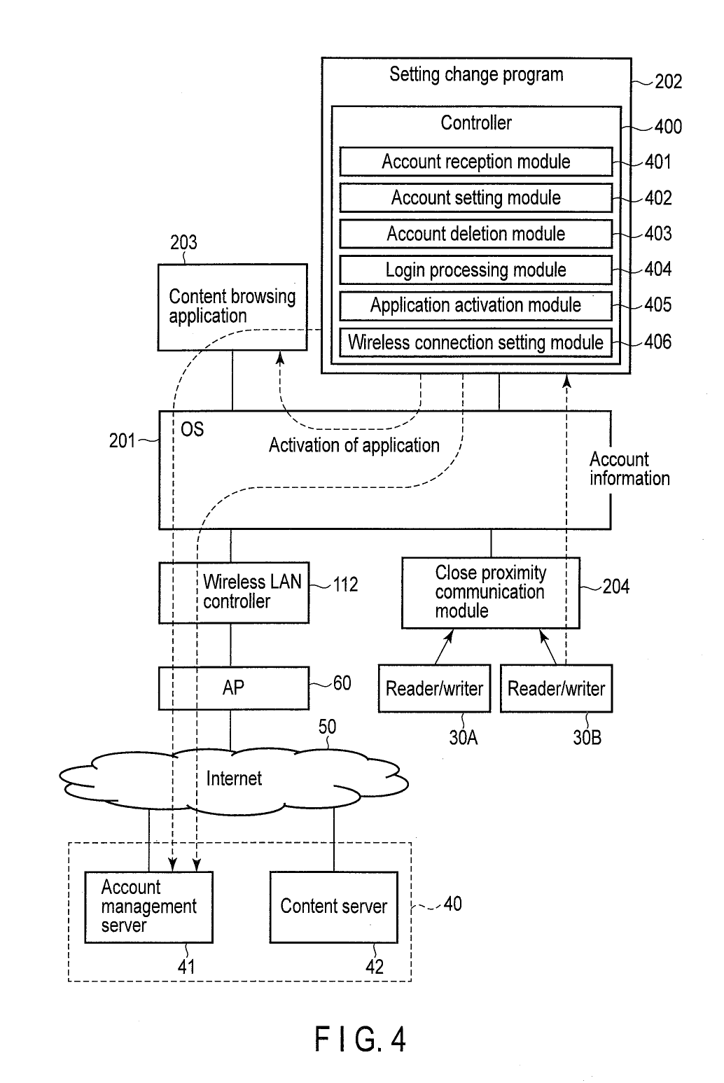

The configuration of the system including the setting change program 202 will be described next with reference to FIG. 4.

The setting change program 202 comprises a controller 400 including an account reception module 401, an account setting module 402, an account deletion module 403, a login processing module 404, an application activation module 405, and a wireless connection setting module 406.

The setting change program 202 operates on an OS 21. The setting change program 202 can change various settings in the tablet computer 10 in accordance with the request received from an external apparatus via the OS 201.

Upon receiving an account setting request from an external apparatus located close to the tablet computer 10 by close proximity communication, a controller 400 receives, from the external apparatus by using close proximity communication, account information for logging in to a server system 40 which provides a specific service. The controller 400 sets the received account information in the tablet computer 10. The external apparatus is, for example, the reader/writer 30A or reader/writer 30B. The server system 40 is a system constituted by a plurality of servers including an account management server 41 which manages accounts and the like created by users and the like, and a content server 42 which provides a content associated with a specific area such as the area 11 as a specific service. Note that the account management server 41 and the content server 42 may be realized by one server. The detailed configuration of the controller 400 will be described below.

Upon receiving a request (to be referred to as an account setting request hereinafter) to set an account in the tablet computer 10 from the reader/writer 30A via the close proximity communication module 204, the account reception module 401 receives account information for logging in to the server system 40 from the reader/writer 30A.

Account information includes an identifier for identifying an account capable of logging in to the server system 40 and a password associated with the account.

The account setting module 402 sets the account information received by the account reception module 401 in the tablet computer 10 as an account to be used for logging in to the server system 40.

Upon receiving a request (to be referred to as an account deletion request hereinafter) to delete account information set in the tablet computer 10 from the reader/writer 30B via the close proximity communication module 204, the account deletion module 403 deletes the above account information set in the tablet computer 10.

The login processing module 404 transmits the account information received by the account reception module 401 to the account management server 41 included the server system 40, and performs processing for logging in to the server system 40. Note that as shown in FIG. 4, a content browsing application 203 may execute the login processing with respect to the account management server 41 based on an instruction from the login processing module 404. Alternatively, the login processing module 404 may log in to the account management server 41 without via the content browsing application 203.

The application activation module 405 activates the content browsing application 203 after the account setting module 402 sets the account information in the tablet computer 10. Note that the application activation module 405 may activate the content browsing application 203, and at the same time, the login processing module 404 may transmit account information to the account management server 41 and log in to the server system 40.

The wireless connection setting module 406 performs the above wireless connection setting. More specifically, the wireless LAN controller 112 detects an AP (Access Point) 60 near the current position of the tablet computer 10. To communicate with the server system 40 connected to an Internet 50 via the detected AP (Access Point) 60 near the current position of the tablet computer 10, the wireless connection setting module 406 sets the detected AP 60 to the communication destination of the wireless LAN controller 112.

Assume that before the account setting module 402 sets account information (first account information) received by the account reception module 401 in the tablet computer 10, another account information for logging in the server system 40 is set in the tablet computer 10. In this case, the controller 400 can temporarily invalidate the another account information and validate the first account information. This makes it possible to log in to the server system 40 by using the first account information in the area 11.

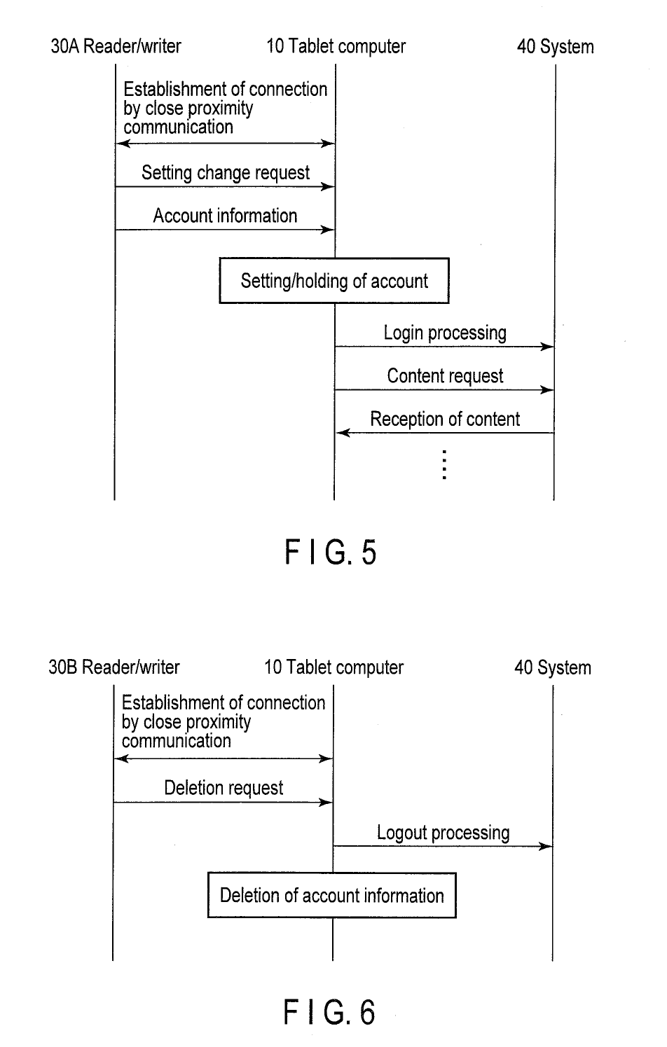

A procedure for processing associated with account information setting performed by the setting change program 202 will be described next with reference to FIG. 5.

First of all, when the tablet computer 10 and the reader/writer 30A close to each other, connection by close proximity communication is established between the tablet computer 10 and the reader/writer 30A. Note that close proximity connection is established in accordance with a general processing procedure required for the establishment of close proximity connection.

After close proximity connection is established, the reader/writer 30A sends a setting change request (account setting request) to the tablet computer 10. Note that the setting change request may include a wireless connection setting change request, a setting change request concerning the volume of the tablet computer 10 or vibration of the tablet computer 10, a time setting change request for the tablet computer 10, or the like, in addition to an account setting request. For example, if it is necessary to change wireless connection settings before account setting (account setting change), the reader/writer 30A requests the tablet computer 10 to change the wireless connection settings. The tablet computer 10 then changes the wireless connection setting in accordance with the wireless connection setting change request.

If, for example, the area 11 like that shown in FIG. 2 is a museum or art museum, the reader/writer 30A changes settings in the tablet computer 10 so as to adjust or turn off the volume of the tablet computer 10 and turn on the vibration sensor 205 (sets the silent mode). In another case, if the area 11 like that shown in FIG. 2 is an airport or the like, the reader/writer 30A can change settings (change an Airplane mode) so as to invalidate (OFF) the wireless connection settings. Assume that the area 11 is an airport or the like. In this case, if a time zone (first time zone) when close proximity communication at the time of entrance is performed is different from a time zone (second time zone) when close proximity communication at the time of exit is performed, the setting change program 202 can change the timing setting in the tablet computer 10. The first time zone is indicative of a time in the area where the reader/writer 30A used in the close proximity communication at the time of entrance is present. The second time zone is indicative of a time in the area where the reader/writer 30B in the close proximity communication at the time of exit is present.

The reader/writer 30A then sends account information to the tablet computer 10. The tablet computer 10 sets and holds the account information sent from the reader/writer 30A in the tablet computer 10 as an account (guest account) to be used to log in to the server system 40. If another account such as a user account different from a guest account is set or held in the tablet computer 10, it is possible to use the guest account in preference to another account by temporarily invalidating the another account and validating the guest account. Note that even if another account such as a user account is temporarily invalidated, the account is held in the tablet computer 10 without being deleted from the tablet computer 10.

The tablet computer 10 then logs in to the server system 40 by using the account information (guest account) set in the tablet computer 10. In this login processing, the tablet computer 10 transmits the account information set in the tablet computer 10 to the server system 40. Based on the identifier included in the account information received from the tablet computer 10, the server system 40 specifies an account (the above guest account), which corresponds to the above identifier, from many accounts managed by the server system 40. The server system 40 then compares the password associated with the specified account (the above guest account) with the password included in the account information received from the tablet computer 10 to determine whether the password included in the account information received from the tablet computer 10 is a correct password. Upon confirming that the password included in the account information received from the tablet computer 10 is a correct password, the server system 40 permits the tablet computer 10 to log in to the server system 40, i.e., use a service associated with the above specified account (the above guest account).

After the tablet computer 10 logs in to the server system 40 by using the guest account, the tablet computer 10 issues a request for a content to the server system 40. In this case, the setting change program 202 of the tablet computer 10 may automatically activate the content browsing application 203 via the OS 201 to make the content browsing application 203 issue a request for a content to the server system 40. The server system 40 sends the content to the tablet computer 10 in accordance with a request for the content sent from the tablet computer 10. In this case, the server system 40 may transmit, to the tablet computer 10, a list of contents which can be browsed under the authority corresponding to the above guest account. If, for example, the area 11 is a museum or art museum, the contents which can be browsed include various contents such as images or videos (moving images) associated with the museum or art museum, and floor maps associated with the museum or art museum. The content browsing application 203 displays the list of contents which can be browsed. When the user selects a content from the content list, the content browsing application 203 issues a request for the selected content to the server system 40. In accordance with the request for the content sent from the tablet computer 10, the server system 40 sends the content to the tablet computer 10. The content browsing application 203 displays an image corresponding to the content received from the server system 40.

A procedure for processing associated with the deletion of account information by the setting change program 202 will be described next with reference to FIG. 6.

First of all, when the tablet computer 10 and the reader/writer 30B close to each other, connection is established between the tablet computer 10 and the reader/writer 30B by close proximity communication. Note that as in the case of FIG. 5, close proximity connection is established in accordance with a general processing procedure required for the establishment of close proximity connection.

The reader/writer 30B then sends a deletion request to delete account information concerning the guest account set in the tablet computer 10 to the tablet computer 10. Note that the reader/writer 30B may make an inquiry about the setting state of the tablet computer 10. The reader/writer 30B may then determine whether, for example, a guest account is set in the tablet computer 10, based on the setting state of the tablet computer 10 which is obtained as a result of the inquiry.

In response to the deletion request from the reader/writer 30B, the tablet computer 10 performs logout processing. In logout processing, tablet computer 10 sends a logout request to the server system 40 while the tablet computer 10 is logged in with a guest account. The tablet computer 10 then deletes the account information concerning the guest account set in the tablet computer 10. Note that to delete account information is to prevent the user from using the guest account.

In association with the above description of this embodiment, the following is a case in which the tablet computer 10 can use a plurality of guest accounts. The reader/writer 30A can transmit account information concerning different types of guest accounts created in advance to the tablet computer 10. Logging in by using the respective guest accounts allows to, for example, browse different types of contents corresponding to the respective guest accounts. The tablet computer 10 stores information concerning guest accounts to be able to use. When performing close proximity communication at the time of entrance, the reader/writer 30A decides which one of guest accounts is to be transmitted, based on information concerning usable guest accounts stored in the tablet computer 10, and transmits the decided account information to the tablet computer 10. Selectively using guest accounts in this way can provide different services (contents) in, for example, a movie theater, passenger plane, or concert hall, in accordance with the classes of admission tickets or the like which users have. In this case, information concerning the classes of the admission tickets or the like which the users have corresponds to information concerning usable guest accounts stored in the tablet computer 10.

In the above description of this embodiment, this apparatus may perform, in the area 11, the processing associated with the activation of the content browsing application 203 or the processing associated with browsing of contents by using the content browsing application 203 in accordance with an instruction from the user.

The timing of using a specific service in the area 11 after close proximity connection at the time of entrance will also be described below. For example, it is assumed the case that an IC tag or the like located in a predetermined place in the area 11 and the tablet computer 10 close to each other and the IC tag or the like and the tablet computer 10 communicate with each other. In this case, the apparatus may perform the processing associated with the activation of the content browsing application 203 or the processing associated with the browsing of a content by using the content browsing application 203.

Referring to FIG. 2, if the tablet computer 10 holds usable user accounts before entrance to the area 11, a user account set or held in the tablet computer 10 before entrance to the area 11 need not be identical to a user account set or held in the tablet computer 10 after exit from the area 11.

Guest accounts and user accounts will be described in more detail below. A guest account is an account created in advance so as to allow the user to use the account when he/she enters the area 11. A user account is an account created by each user who enters the area 11 before he/she enters the area 11.

As described above, according to this embodiment, account information for logging in to a server system 40 which provides a certain service is received from an external apparatus by using close proximity communication, and the account information is set in the tablet computer 10. This allows the user to set the account information using the function of the NFC provided in the tablet computer 10 by only holding the tablet computer 10 over an external apparatus. In addition, it is possible to, for example, change, add, or delete account information as well as setting account information. When a user boards a passenger plane or disembarks from the passenger plane, or enters public facilities or exits public facilities, it is possible to make settings in the tablet computer 10 or cancel settings in the tablet computer 10 without user operation. It is possible to make such a change in setting at time of entrance/exit regardless of whether the user wants the change. It is also possible to allow the tablet computer 10 to use, information such as a password concerning a guest account which can be used in only public facilities or the like, and/or information such as a password concerning the AP (Access Point) 60 for wireless connection which can be used in public facilities or the like, without notifying the user of these pieces of information. More specifically, by deleting these pieces of information when the user exits from public facilities or the like, it is possible to use the information only in the public facilities or the like.

All the processing procedures described in this embodiment can be implemented by software. It is therefore possible to easily achieve the same effects as those of the embodiment by only installing computer programs for executing these processing procedures in a general computer via a computer readable storage medium storing the programs and executing computer programs.

In addition, the function of each module shown in FIG. 4 may be implemented by hardware such as a custom LSI and DSP.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a close proximity communicator configured to execute close proximity communication; and
a controller configured to receive, by using the close proximity communication, first account information from an external apparatus close to the electronic apparatus in response to an account setting request from the external apparatus, and to set the first account information in the electronic apparatus, wherein the first account information is for logging in to a server system configured to provide a certain service.

2. The apparatus of claim 1, wherein the controller is further configured to delete the first account information set in the electronic apparatus in response to an account deletion request from the external apparatus.

3. The apparatus of claim 1, wherein the controller is further configured to temporarily invalidate second account information for logging in to the server system and validates the first account information, if the second account information is set in the electronic apparatus.

4. The apparatus of claim 1, wherein the controller is further configured to activate an application program for use of the certain service and transmit the first account information to the server system to log in to the server system, after the first account information is set in the electronic apparatus.

5. The apparatus of claim 1, wherein the first account information comprises an identifier to identify a first account to log in to the server system and a password associated with the first account.

6. The apparatus of claim 1, further comprising a wireless communicator configured to connect the electronic apparatus to a wireless network,
wherein the controller is further configured to set an access point near a current position of the electronic apparatus as a communication destination of the wireless communicator so as to execute communication with the server system via the access point, wherein the access point is configured to be detected by the wireless communicator.

7. A control method of an electronic apparatus comprising a close proximity communicator configured to execute close proximity communication, comprising:
receiving, by using the close proximity communication, first account information from an external apparatus close to the electronic apparatus in response to an account setting request from the external apparatus, wherein the first account information is for logging in to a server system configured to provide a certain service; and
setting the first account information in the electronic apparatus.

8. A computer-readable, non-transitory storage medium comprising a computer program configured to be executed by a computer, the computer comprising a close proximity communicator configured to execute close proximity communication, the computer program controlling the computer to execute functions of:
receiving, by using the close proximity communication, first account information from an external apparatus close to the computer in response to an account setting request from the external apparatus, wherein the first account information is for logging in to a server system configured to provide a certain service; and
setting the first account information in the computer.
